(19) United States
(12) Patent Application Publication
(10) Pub. No.: US 2002/0116624 A1
(43) Pub. Date: Aug. 22, 2002

(54) Embedded cryptographic system

(75) Inventors: James F. Riordan, Adilswil (CH); Dominique Alessandri, Zurich (CH)

Correspondence Address: HARRINGTON & SMITH, LLP, 1809 BLACK ROCK TURNPIKE, FAIRFIELD, CT, 06432, US

(73) Assignee: International Business Machines Corporation, Armonk, NY

(21) Appl. No.: 10/058,661

(22) Filed: Jan. 28, 2002

(30) Foreign Application Priority Data
Feb. 16, 2001 (EP) 01810155.0

(51) Int. Cl. H04L 9/32

(52) U.S. Cl. 713/193; 713/191

(57) ABSTRACT

An embedded cryptographic system comprises at least one test plaintext/ciphertext pair Pᵢ, Cᵢ for which the key has been destroyed or stored at a very safe place. If at some later date, at least one apoptosis key Kᵢ is presented to the cryptographic system which has the property that Cᵢ is the enciphered image of Pᵢ under K_{i,} then the algorithm could be broken and should not be used any more. Instead a more conservative algorithm should be used. The method for changing the ciphering by an embedded cryptographic system includes the step of checking whether at least one test ciphertext Cᵢ is the enciphered image of a corresponding test plaintext Pᵢ under a apoptosis key Kᵢ and the step of switching off the used cryptographic mode or the step of switching to an other cryptographic mode in case of a positive checking result. In order to enable the step of checking a protocol has to define a control stream with at least one key to be checked. The checking will be done as soon as such a control stream is received by the cryptographic system. The advantage of this solution is the fact, that there is no need for controlling respectively trusting the manufacturer or a security service. The embedded cryptographic system can receive the key or a collection of keys {Kᵢ} from anywhere.

### FIELD OF THE INVENTION

The present invention relates to cryptographic systems. More particularly the invention relates to an embedded cryptographic system and methods for creating and operating the system for carrying out cryptographic operations.

### BACKGROUND OF THE INVENTION

Secure data transfer is commonly achieved by the use of cryptographic algorithms. Embedded cryptographic systems, subsystems and devices are used in many applications such as banking and the creation of virtual networks. Wireless LAN network adapters, cash dispensers (ATM), Smartcard Cellphones (GSM) and Gambling devices are examples which can include embedded cryptographic systems. The term embedded cryptographic system is used for embedded systems, subsystems or services and devices, which are used for cryptographic tasks. Such cryptographic systems use an input stream in order to create from it an output stream.

While embedded cryptographic devices typically require very high performance, the algorithms are often implemented in hardware (rather than software) towards performance advantage. Embedded cryptographic systems are comprised of computer software and/or hardware or electronics. Their interfaces are very limited for security reasons. Embedded cryptographic devices are very difficult to upgrade. An upgrade generally requires trusted and expert field service agents to physically access the embedded cryptographic device. Doing so is time consumptive and expensive.

At the same time cryptographic algorithms are evolving. This evolution recently took a quantum leap due to the request of the US National Institute of Standards (NIST) for a replacement cipher respectively an advanced encryption standard (AES) for DES, the most commonly used block cipher. In the near future, embedded cryptographic systems will offer the choice between triple DES (DES run three times) and the winner of the AES competition, which is now known to be Rijndael. The advantage of the former is that it is well tested. The advantage of the latter is that it is faster and more flexible.

The problem is that any cipher algorithm and therefore also the winner of the AES competition (Rijndael), could be suddenly crypt-analyzed and broken. Should such a break be a catastrophic break, then the risk of finding individual keys and therefore the risk of unauthorized deciphering and enciphering secure information is very high. Attacking of cryptographic equipment is described by Ross Anderson and Markus Kuhn in “Tamper Resistance—a Cautionary Note ”, The Second USENIX Workshop on Electronic Commerce Proceedings, Oakland, Calif. Nov. 18-21 1996, pages 1-11, ISBN 1-880446-83-9. A successful attack of accessible cryptographic systems should not be disastrous for the whole system. The authors conclude that most current electronic wallet systems use symmetric cryptography with universal secrets stored in retailers terminals and that they should be designed to keep on working after these secrets have been compromised—such as by supporting a fallback processing mode.

In the case of physical penetration of a cryptographic system, there are self-destruct mechanisms known, which allow, for example, to erase the key at the penetrated system. If the algorithm of a series of cryptographic systems is broken, then it is necessary to have a possibility to shut down the operation of the systems of this series or to switch to a fallback mode. A cryptographic system is broken as soon as some one discovers a fast algorithm for finding individual secret keys. The result of breaking an algorithm could be potentially disastrous because the embedded cryptographic systems are implemented in an increasing number of applications with secret information. If a trusted and expert field service agent has to get physically access to all the systems with a broken cryptographic system, then the harm due to illegally acquired information and illegally sent information or instructions could be high, because of the long time needed for the replacement of all the broken embedded cryptographic systems.

In the field of rather complex systems a concept for secure shutting down of mobile services is described by Christian Tschudin “Apoptosis the Programmed Death of Distributed Services”, in J. Vitek and C. Jensen, editors, Secure Internet Programming—Security Issues for Mobile and Distributed Objects, pages 253-260, Springer, 1999. Active networks with services run by mobile code have to have the functionality of creating and ending services. The apoptosis concept of self-destructing mobile services is borrowed from cell biology and designates there the programmed cell death. The apoptosis process is suggested to start as for cells by two different ways. A service may depend on a continuous stream of credentials or positive signals. Once these credentials run out, the service will shut down. According to the second way a negative signal causes the service to shut down.

The apoptosis entry point of a mobile service would be a primary target for an attack. Therefore the apoptosis concept should be implemented with cryptographic security functions. Cryptographic security functions are described by J. Riordan and B. Schneier, Environmental Key Generation Towards Clueless Agents, in G. Vigna, editor, Mobile Agents and Security, volume 1419 of LNCS, pages 15-24, Springer, 1998. The shut down could be induced by an apoptosis activator. Applying the above mentioned apoptosis concept does not change the disadvantage that a system administrator or a security service provider has to induce the shut down procedure.

### SUMMARY OF THE INVENTION

In accordance with the present invention, there is now provided a method for stopping cryptographic operations with a first cryptographic algorithm and preferably reverting to a second cryptographic algorithm. A cryptographic system or a device is configured in such a way that it enables stopping the cryptographic operations with the first cryptographic algorithm and preferably reverting to the second cryptographic algorithm.

The notation is used as follows:

Pᵢ is a plaintext (un-enciphered),

Kᵢ is a key for a enciphering algorithm, and

Cᵢ is the plaintext Pᵢ enciphered with the key Kᵢ.

Symmetric cryptographic systems are using the same key for deciphering the enciphered text Cᵢ.

It is assumed that if a person finds at least one particular key Kᵢ then it is most likely that this person has broken the cryptographic algorithm. In order to prevent that a particular key is just found by change, breaking the cryptographic algorithm can be bound to finding more then one particular key. By knowing a fast algorithm for finding keys it is possible to find any individual key used to create a given enciphered text. Therefore the whole series of embedded cryptographic systems with the same cryptographic algorithm is attacked. The security of the information handled by any specific embedded cryptographic system is no more guaranteed.

In a preferred embodiment of the present invention, added to each embedded cryptographic system is at least one test plaintext/ciphertext pair, respectively a series of test plaintext/ciphertext pairs {(Pᵢ/Cᵢ)}, for which the key respectively keys have been destroyed or stored in a very safe place. If at some later date, at least one apoptosis key Kᵢ is presented to the cryptographic system which has the property that Cᵢ is the enciphered image of Pᵢ under Kᵢ, then the algorithm could be broken and should not be used any more. Instead a more conservative algorithm preferably Triple DES should be used. The method for changing the ciphering by an embedded cryptographic system preferably includes the step of checking whether at least one test ciphertext Cᵢ is the enciphered image of a corresponding test plaintext Pᵢ under a apoptosis key Kᵢ and the step of switching off the used cryptographic mode or the step of switching to an other cryptographic mode in case of a positive checking result. In order to enable the step of checking a protocol has to define a control stream with at least one key to be checked. The checking will be done as soon as such a control stream is received by the cryptographic system.

The steps of checking and switching can be implemented in the cryptographic system by software or by hardware. The cryptographic system needs to include checking means for checking whether the test ciphertext Cᵢ is the enciphered image of the test plaintext Pᵢ under a received key Kᵢ. In addition to the checking means the cryptographic system also has to include switching means for switching off the used cryptographic mode or for switching to an other cryptographic mode in case of a positive checking result. The cryptographic system includes memory means for storing at least one plaintext/ciphertext pair {(Pᵢ/Cᵢ)}.

An advantage of this solution is that there is no need for controlling respectively trusting the manufacturer or a security service. The embedded cryptographic system can receive the key or a collection of keys {Kᵢ} from anywhere. If the test ciphertext Cᵢ stored at the cryptographic system is under Kᵢ the enciphered image of the test plaintext Pᵢ also stored at the system, then there is an objective risk for the cryptographic system. The check needed by the cryptographic system includes the step of enciphering at least one test plaintext Pᵢ with the received key Kᵢ and the step of controlling whether the enciphered text corresponds to the stored test ciphertext Cᵢ. It will be understood that instead or in addition to enciphering the stored plaintext Pᵢ the check could as well be done by deciphering the enciphered text Cᵢ. The apoptosis key Ki is most likely the result of breaking the algorithm. Therefore the embedded cryptographic system can switch itself of or switch from the possibly broken first algorithm to a secure second one.

Since the cryptographic system can accept the key or a collection of keys {Kᵢ } from anywhere or anyone, keys can be sent by the manufacturer of the cryptographic system, by a security provider or even by hackers who are proud to have broken the algorithm. The at least one test plaintext/ciphertext pair, respectively a series of test plaintext/ciphertext pairs {(Pᵢ/Cᵢ )}, for which the key respectively keys have been destroyed or stored in a very safe place will be published, so that any person can try to break the algorithm and find the corresponding keys. Instead of or in addition to the publishing, the test plaintext/ciphertext pairs could be delivered to a limited group of specialists, who are trying to brake the algorithm. If the algorithm is broken by a hacker who does not present the key for the at least one test plaintext/ciphertext pair, then it is advantageous for the manufacturer to have the key, respectively keys, stored. The manufacturer or the security provider has to release or broadcast the key to the public to activate the switching of the cryptographic system. In case it is assumed but not evident whether a given cryptographic algorithm has been broken, then the switching can only be done if the key has not been destroyed. In the other case where it is known how a given cipher can be broken, anyone can recalculate the key based on a publicly known test plaintext/ciphertext pair and release or broadcast the key to the public thereby activating the switching mechanism. When it becomes evident that a cipher has been broken, one should find out whether the algorithm to break a cipher is known or not and whether the break is catastrophic.

Instead of destroying the keys used to create test plaintext/ciphertext pairs, collection of plaintext/ciphertext pairs {(Pᵢ=Cᵢ)} can be created so that no one person knows any of the Kᵢ. This is done using a method called multi-party computation. Since the multi-party computation is sufficiently painful, it is probably more easy just to get a bunch of people together in a Faraday cage and to melt the computer afterwards. This procedures is already used to prevent theft of important secrets.

The cryptographic system includes input/output means for receiving input streams and sending output streams wherein said input streams are transformed to said output streams by cryptographic operations. The cryptographic system should as well be able to accept a control stream including at least one apoptosis key Kᵢ. This control stream can be received by receiving means for receiving control streams. Instead of accepting the control stream at a special interface it could as well be accepted at the same input/output means as the input streams are accepted. The control stream is to be defined by a protocol. In order to make sure that the sent apoptosis keys are relevant for the cryptographic system receiving it, the keys can be sent with the corresponding plaintext/ciphertext pairs.

### BRIEF DESCRIPTION OF THE DRAWINGS

Preferred embodiments of the present invention will now be described with reference to the accompanying drawings, in which:

FIG. 1 is a block-diagram view of a cryptographic system for carrying out cryptographic operations, and

FIG. 2 is a block-diagram view of the cryptographic system of FIG. 1 with an interface.

### DETAILED DESCRIPTION OF THE PREFERRED EMBODIMENTS

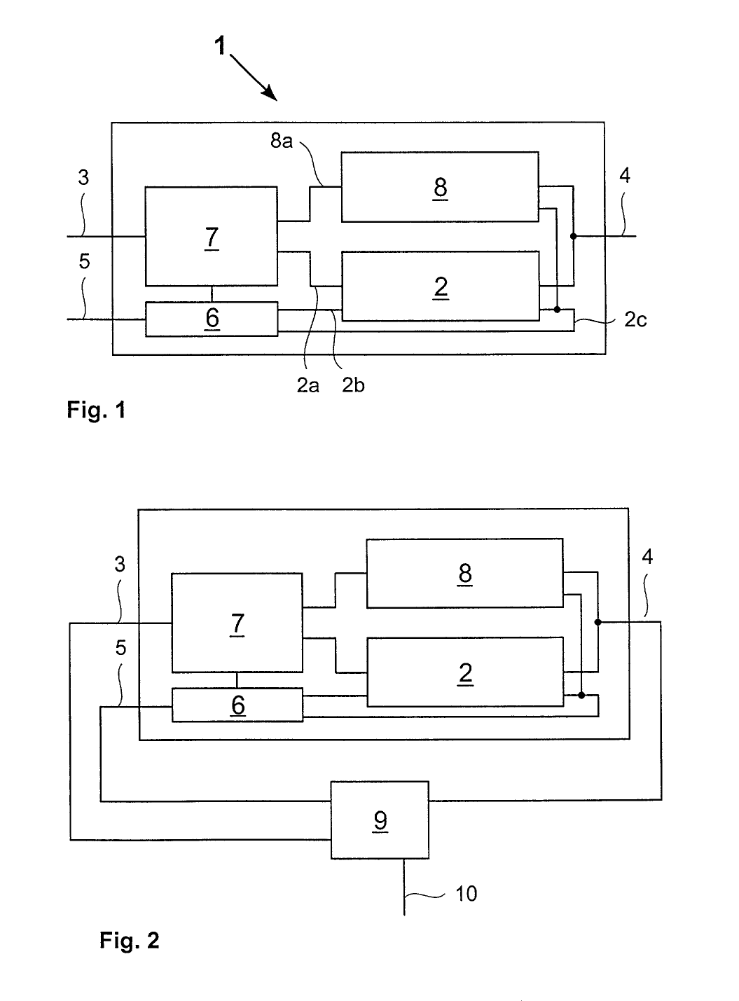

FIG. 1 shows a cryptographic system for carrying out cryptographic operations. The system comprises a first cryptographic algorithm means 2, which can be the Rijndael algorithm, for enabling the cryptographic operations. In general, the term cryptographic operation can be understood as a mathematical transformation on the represented form of data as to effect confidentiality, verifiable authenticity, integrity, temporality, non-reputability, et cetera executed in a manner as to resist adversarial alteration. In the embodiment according to FIG. 1 a secret first key is located within the first cryptographic algorithm means 2 and it will be used for ciphering data which is inputted through input line 2a. If the first cryptographic algorithm is not symmetric, then a special protocol or two separate input lines 2a—one for enciphering and one for deciphering—would make sure that the right algorithm is used. The cryptographic system receives input streams from input means 3 and sends output streams by output means 4. The input streams are transformed to output streams by the cryptographic operation. An input stream can be a plaintext or an enciphered text. The corresponding output stream is an enciphered text, respectively a deciphered text.

Receiving means 5 are used to receive a control stream which is including at least one apoptosis key Kᵢ. The receiving means 5 and the input means 3 could be the same means, wherein the distinction between an input stream and a control stream would have to be made by a defined protocol. The control stream is supplied to checking means 6. At least one test plaintext Pᵢ and for each test plaintext Pᵢ a corresponding test ciphertext Cᵢ are preferably located within the checking means 6. If there is only one test plaintext Pᵢ then this test plaintext Pᵢ along with the apoptosis key Kᵢ of a received control stream will be supplied through a further input line 2b to the first cryptographic algorithm means 2. The input of this further input line 2b is enciphered under the first cryptographic algorithm and with the apoptosis key Kᵢ. The resulting enciphered plaintext Pᵢ is supplied to the checking means 6 by an interconnecting means 2c . The checking means 6 performs a step of comparing the resulting enciphered plaintext Pᵢ with the stored test ciphertext Cᵢ. If the comparing shows correspondence then the checking means 6 triggers a switching means 7 to stop the ciphering by the first cryptographic algorithm means 2. A continued cryptographic operation can be enabled by switching to a second cryptographic algorithm means 8, which can be Triple DES or IDEA for example. Also possible is to apply a cascaded list of different cryptographic algorithm means and switch to them in the defined order. The resulting enciphered plaintext Pᵢ is supplied to the checking means 6 by an interconnecting means 2c. In the embodiment according to FIG. 1 the secret second key is located within the second cryptographic algorithm means 8 and it will be used for ciphering data which is inputted through input line 8a.

The embodiments of FIG. 1 and 2 have one second cryptographic algorithm means 8. There could be more then one such second cryptographic algorithm means 8 wherein a ranking can be used to select further cryptographic algorithm means. Also, a cascading list of different cryptographic algorithm means can be applied. The selected second cryptographic algorithm means 8 could then be looked at being the first cryptographic algorithm means and an apoptosis key or set of keys for this new first cryptographic algorithm means could trigger switching to an other second cryptographic algorithm means. The checking means 6 would have to replace the test plaintext/ciphertext pairs of the initial first cryptographic algorithm by test plaintext/ciphertext pairs of the new first cryptographic algorithm.

A cryptographic algorithm is not broken if just one particular key has been found without a fast algorithm to find any secret key. To prevent unnecessary stopping of still secure first cryptographic algorithms it is reasonable to ask for at least two apoptosis keys. The apoptosis keys of a control stream with two or more apoptosis keys Kᵢ should preferably be assigned to corresponding test plaintext/ciphertext pairs Pᵢ,Cᵢ. If a control stream includes with each apoptosis key Kᵢ the corresponding test plaintext/ciphertext pairs Pᵢ, Cᵢ, then the assignment can be done by trying to find a test plaintext/ciphertext pair Pᵢ, Cᵢ being equal to a particular one of the received plaintext/ciphertext pairs Pᵢ, Cᵢ. The checking will be done with the apoptosis key of this equal test plaintext/ciphertext pair Pᵢ,Cᵢ. The stopping will only be triggered as soon as a given number—at least two—of with apoptosis keys are found to be the correct keys of given test plaintextlciphertext pairs Pᵢ, Cᵢ. A solution without assignment would check each apoptosis key with each test plaintext/ciphertext pair Pᵢ, Cᵢ. Such a solution would preferably use control streams just with apoptosis keys. It would be checked whether a test ciphertext Cᵢ is the enciphered image of the corresponding test plaintext Pᵢ under the first cryptographic algorithm when using a transmitted apoptosis key Kᵢ.

FIG. 2 shows the cryptographic system of FIG. 1 with an interface 9 to an external system or network 10. The interface 9 controls the data flow to the receiving means 5 and the input means 3 and from the output means 4. This data flow control will be done according to a defined protocol.

The present invention can be realized in hardware, software, or a combination of hardware and software Therefore the expression “means ” stands for hardware, software, or a combination of hardware and software. Any kind of computer system—or other apparatus adapted for carrying out the methods described herein—is suited. A typical combination of hardware and software could be a specialized cryptographic processor or a general purpose computer system with a computer program that, when being loaded and executed, controls the computer system such that it carries out the method described herein. The present invention can also be embedded in a computer program product, which comprises all the features enabling the implementation of the methods described herein, and which—when loaded in a computer system—is able to carry out these methods.

Computer software product or computer program in the present context means any expression, in any language, code or notation, of a set of instructions intended to cause a system having an information processing capacity to perform a particular function either directly or after either or both of the following a) conversion to another language, code or notation; b) reproduction in a different material form.

In a preferred example of the present invention, there is provided a method for creating a cryptographic system, which can be altered from a remote site. The creation of this system comprises the following steps:

implementing a first cryptographic algorithm enabling the cryptographic operations,

selecting at least one test plaintext Pᵢ and enciphering each test plaintext Pᵢ with the first cryptographic algorithm and with a corresponding apoptosis key Kᵢ thereby generating a corresponding test ciphertext Cᵢ for each test plaintext Pᵢ,

implementing at least one test plaintext Pᵢ and for each test plaintext Pᵢ the corresponding test ciphertext Cᵢ,

implementing receiving means for receiving a control stream which is including at least one apoptosis key Kᵢ,

implementing checking means for checking whether the at least one test ciphertext Cᵢ is the enciphered image of the corresponding test plaintext Pᵢ under the first cryptographic algorithm when using the apoptosis key Kᵢ,

implementing switching means for stopping the cryptographic operations with the first cryptographic algorithm, wherein the stopping by the switching means is triggered by the checking means.

In order to enable the operation in a fallback mode the method preferably further comprises the following steps: implementing at least one second cryptographic algorithm, giving the switching means the functionality to switch to at least one second cryptographic algorithm.

The manufacturer of a cryptographic system, which can be altered by sending apoptosis keys, will preferably publishing the at least one test plaintext Pᵢ and for each test plaintext Pᵢ the corresponding test ciphertext Cᵢ. The key for such a test plaintext/ciphertext pair will be destroyed or stored in a very safe place.

Now that the invention has been described by way of the preferred embodiment, various modifications and improvements will occur to those of skill in the art. Thus, it should be understood that the preferred embodiment has been provided as an example and not as a limitation. The scope of the invention is defined by the appended claims.

1. A cryptographic system (1) comprising
first cryptographic algorithm means (2) for enabling cryptographic operations,
input/output means (3, 4) for receiving input streams and sending output streams wherein said input streams are transformed to said output streams by said cryptographic operations,
at least one test plaintext Pᵢ and for each test plaintext Pᵢ a corresponding test ciphertext Cᵢ,
receiving means (5) for receiving a control stream which is including at least one apoptosis key Kᵢ,
checking means (6) for checking whether said at least one test ciphertext Cᵢ is the enciphered image of the corresponding test plaintext Pᵢ under the cryptographic operation of said first cryptographic algorithm means (2) when using said apoptosis key Kᵢ,
switching means (7) for stopping said cryptographic operations with said first cryptographic algorithm means (2), wherein said stopping by said switching means (7) is triggered by said checking means (6).

2. System as claimed in claim 1, wherein said cryptographic system (1) includes at least one second cryptographic algorithm means (8) wherein said switching means (7) enables switching to said at least one second cryptographic algorithm means (8).

3. System as claimed in claim 1, wherein
said receiving means (5) is made for accepting control streams which include at least one plaintext Pᵢ, for each plaintext Pᵢ a corresponding ciphertext Cᵢ and a corresponding apoptosis key Kᵢ and
said checking means (6) is made for trying to find a test plaintext Pᵢ and a test ciphertext Cᵢ equal to said received plaintext Pᵢ, wherein said checking is done with said apoptosis key of said equal test plaintext Pᵢ and said equal test ciphertext Cᵢ.

4. System as claimed in claim 1 further comprising a cascaded list of different cryptographic algorithm means.

5. A method for creating a cryptographic system (1) for carrying out cryptographic operations characterized by the steps of
implementing within said cryptographic system (1) a first cryptographic algorithm enabling said cryptographic operations,
selecting at least one test plaintext Pᵢ and enciphering each test plaintext Pᵢ with said first cryptographic algorithm and with a corresponding apoptosis key Kᵢ thereby generating a corresponding test ciphertext Cᵢ for each test plaintext Pᵢ,
implementing within said cryptographic system (1) said at least one test plaintext Pᵢ and for each test plaintext Pᵢ said corresponding test ciphertext Cᵢ,
implementing within said cryptographic system (1) receiving means (5) for receiving a control stream which is including at least one apoptosis key Kᵢ,
implementing within said cryptographic system (1) checking means (6) for checking whether said at least one test ciphertext Cᵢ is the enciphered image of the corresponding test plaintext Pᵢ under said first cryptographic algorithm when using said apoptosis key Kᵢ,
implementing within said cryptographic system (1) switching means (7) for stopping said cryptographic operations with said first cryptographic algorithm, wherein said stopping by said switching means (7) is triggered by said checking means (6).

6. Method as claimed in claim 5, further comprising the step of
implementing within said cryptographic system (1) at least one second cryptographic algorithm for said ciphering operations, and switching by said switching means (7) to said at least one second cryptographic algorithm.

7. Method as claimed in claim 5, further comprising the step of
publishing said at least one test plaintext Pᵢ and for each test plaintext Pᵢ said corresponding test ciphertext Cᵢ.

8. A method for operating a cryptographic system (1) for carrying out cryptographic operations characterized by the steps of
providing a first cryptographic algorithm for enabling said cryptographic operations,
receiving input streams and sending output streams wherein said input streams are transformed to said output streams by said cryptographic operations,
receiving a control stream which is including at least one apoptosis key Kᵢ,
checking whether a test ciphertext Cᵢ is the enciphered image of a corresponding test plaintext Pᵢ under said first cryptographic algorithm when using said apoptosis key Kᵢ,
stopping said cryptographic operations with said first cryptographic algorithm, if said test ciphertext Cᵢ is the enciphered image of said corresponding test plaintext Pᵢ under said first cryptographic algorithm when using said apoptosis key Kᵢ.

9. Method as claimed in claim 8, further comprising the step of
switching to one of said second cryptographic algorithms for said cryptographic operations after said stopping.

10. Method as claimed in claim 8, wherein
said receiving of a control stream includes for each apoptosis key Kᵢ receiving of a plaintext Pᵢ and a corresponding ciphertext Cᵢ, and
said checking includes trying to find a test plaintext Pᵢ and a test ciphertext Cᵢ equal to said received plaintext Pᵢ, and said received ciphertext Cᵢ wherein said checking is done with said apoptosis key of said equal test plaintext Pᵢ and said equal test ciphertext Cᵢ.

11. A computer software product for operating a cryptographic system (1) for
carrying out cryptographic operations, said product is characterized by a computer-readable medium in which program instructions are stored, which instructions,
when read by a computer, enable the computer to perform a first cryptographic algorithm that is enabling said cryptographic operations,
receive input streams and send output streams wherein said input streams are transformed to said output streams by said cryptographic operations,
receive a control stream which is including at least one apoptosis key Kᵢ,
check whether a test ciphertext Cᵢ is the enciphered image of a corresponding test plaintext Pᵢ under said first cryptographic algorithm when using said apoptosis key Kᵢ,
stop said cryptographic operations with said first cryptographic algorithm, if said test ciphertext Cᵢ is the enciphered image of said corresponding test plaintext Pᵢ under said first cryptographic algorithm when using said apoptosis key Kᵢ.

12. Computer software product as claimed in claim 10, wherein said instructions,
when read by a computer, enable the computer to perform at least a second cryptographic algorithm and switch to said at least one second cryptographic algorithms for said cryptographic operations after said stopping.

13. Computer program comprising program code means for performing the steps of any of the claims 8 to 10 when said program is run on a computer.
